(19) United States
(12) Patent Application Publication
(10) Pub. No.: US 2006/0182449 A1
(43) Pub. Date: Aug. 17, 2006

(54) Optical transmitter with integrated amplifier and pre-distortion circuit

(76) Inventors: John Iannelli, San Marino, CA (US); Albert Lu, Hacienda Hts., CA (US)

Correspondence Address: Casey Toohey;Emcore Corp., 1600 Eubank Blvd., SE, Albuquerque, NM, 87123, US

(21) Appl. No.: 11/059,790

(22) Filed: Feb. 16, 2005

(51) Int. Cl. H04B 10/04

(52) U.S. Cl. 398/186

(57) ABSTRACT

An optical transmitter including a housing containing an electrical input disposed in said housing for receiving an information signal; an amplifier for electronically amplifying the input signal; and a laser connected to the output of the amplifier for generating a modulated light beam corresponding to the information signal that is emitted externally from said housing.

### REFERENCE TO RELATED APPLICATIONS

This application is related to copending U.S. patent application Ser. No. filed Jan. ______, 2005, of Rongsheng Miao et al. entitled “Coaxial Cooled Laser Modules with Integrated Thermal Electric Cooler and Optical Components” and assigned to the common assignee.

### BACKGROUND OF THE INVENTION

1. Field of the Invention

The invention relates to optical transmitters and, in particular to packaged assemblies or hermetically sealed modules that provide a communications interface between a computer or communications unit having an analog or digital electrical output signal and an optical fiber, such as used in fiber optic communications system.

2. Description of the Related Art

A variety of optical transmitters are known in the art which include a modulator circuit that converts an analog or digital electrical signal from a computer or communications unit into a modulated current that is applied to a semiconductor laser module, which generates a modulated optical signal or light beam that is coupled to an optical fiber.

Optical transmitters for analog applications have wide application in CATV, interactive TV, and video telephone transmission, for example. Current state of the art optical transmitters typically employ a printed circuit board (PCB) populated with discrete RF circuits (gain stages, pre-distortion circuits, etc.) coupled to a packaged laser module. Typically the laser module includes a semiconductor laser coupled to a fiber optic transmission medium with coupling optics such as a lens or window, and is mounted on the PCB with electrical contacts being made by leads on one or both sides of the package.

Prior art modules sometimes include an impedance matching resistor for matching the impedance of the laser (typically about four ohms), with the input impedance of the module (typically 25 ohms in CATV applications), and a thermoelectric cooler (TEC) to temperature stabilize the laser and perhaps other associated components inside the module. If an impedance matching resistor is used in series with the laser, the voltage swing of the external laser driver must be increased to provide adequate modulation current to drive the laser. Such large voltage swings require increased laser driver supply voltages and increase overall system power dissipation. As a result, such prior art transmitters are relatively large and consume a substantial amount of power, typically over ten watts.

In addition, another drawback of prior art modules is that the discrete components of typical analog transmitters are interconnected by transmission lines typically in the form of microstrips. In most systems, both ends of the transmission line are impedance matched to the impedance of the transmission line (e.g. 75 ohms in cable systems) to prevent waveform distortion caused by RF (radio frequency) reflections. However the use of impedance matching resistors shunted to ground between electrical components further increases the power dissipation and transmitter heat load in the laser module. In addition, the integration of the discrete RF circuits and the laser module on the PCB typically results in relatively large transmitters with relatively high cost and low density.

The amplifier used in prior art optical transmitters, such as the Anadigics ACA2304 integrated circuit, dissipates a substantial amount of heat (around six watts) and takes up a large amount of space on the printed circuit board. Another issue is that the amplifier is typically spaced from the laser diode by several inches, and therefore such design requires some form of impedence matching circuitry (for example, a transformer) be used between the amplifier circuit and the laser diode. Thus, although it is desirable to reduce the size and power requirements of optical transmitters for analog RF applications, prior to the present invention it has not been possible to implement an amplifier integrated circuit inside a laser package because of the relatively large size of the integrated circuit and its associated power requirements and heat dissipation issues.

Another component that may be located within the laser module is the pre-distortion circuitry, or pre-distorter. Although such circuitry does not consume as much power as the amplifier, it is also advantageous for such circuitry to be located within the same package. Again, however, prior to the present invention, pre-distorters and laser modules have been separately designed and implemented, and therefore in currently available optical transmitters, such circuitry has been implemented on a printed circuit board on which the standard commercially available laser package is also mounted.

As mentioned above, one method employed in the prior art to reduce distortion inherent in lasers or other nonlinear devices has been the use of predistortion circuits. In this technique, a circuit is provided to combine the modulation signal with a predetermined signal that is equal in magnitude to the distortion inherent in the nonlinear device but opposite in sign. When the nonlinear signal conversion device (i.e, the laser) is modulated by the combined distortion-corrected signal produced by such circuit, the device's inherent distortion is cancelled by the combined signal's predistortion and only linear part of the source signal is converted into an optical signal. The predistortion signal is usually in the form of additive and subtractive combinations of the input fundamental frequencies as these intermodulation products constitute the most fertile source of distortion in analog signal transmission. In the distribution of AM signals for cable television, for example, there are often as many as 110 frequencies on a particular band and plenty of opportunities for second order and third order intermodulation products of those frequencies to occur within the transmission band.

These predistortion circuits have been used in current commercial 1310 nm and 1550 nm optical transmitters and are exemplified by U.S. Pat. No. 6,288,814 which is hereby incorporated by reference.

Some of the early predistortion techniques generally divide an input signal into two or more electrical paths and generate predistortion on one or more of the paths resembling the distortion inherent in the nonlinear transmitting device. The generated predistortion is the inverse of the nonlinear device's inherent distortion and serves to cancel the effect of the device's inherent distortion when recombined with the input signal. Attenuation can be used to match the magnitude of the predistortion to the magnitude of the devices inherent distortion characteristics before the signals are recombined and sent to the nonlinear device for modulation. However, the method suffers from crudeness because nonlinear devices frequently have amplitude and phase distortion characteristics dependent on the frequency of the modulating signal. More recent techniques provide means for compensating for these frequency-dependent nonlinearities.

Neglecting to correct for the frequency dependence of the distortion leads to a result which may be quite tolerable for many systems and for signals with relatively narrow bandwidth. However, they become particularly troublesome when converting an electrical TV signal to an optical signal for cable transmission. Such signals for cable TV may have 40 or more input frequencies, all of which need to have high quality amplitude modulated signals. The transmission devices for such signal must have an exceptionally high degree of linearity.

Advanced multi-path circuits are flexible and highly effective for linearizing output of a wide range of nonlinear devices. One such multi-path predistortion circuit is disclosed in U.S. Pat. No. 4,992,754, issued to Blauvelt et al. The circuit is capable of generating frequency specific distortion products for compensating frequency-dependent nonlinearities, and is useful for applications requiring an exceptionally high degree of linearity, such as, for example, CATV applications.

Although multi-path distortion circuits can be used in a broad variety of applications, the design of these circuits is relatively complex. This complexity manifests itself in circuits that are often too expensive for applications needing only a modest degree of linearization. One skilled in the art would appreciate a low-cost circuit of relatively simple design for limited application, particularly if such a circuit were fabricated from existing low-cost components commonly used in signal transmission applications.

Circuits as described here could produce frequency dependent third-order distortion. Simple third-order distortion, such as that produced by an ideal diode, has the property that the distortion is real and independent frequency. Many non-linear transmitters or amplifiers, however, contain reactive elements such as inductance capacitances or delays, which cause the device to produce distortion depending on the input and output frequencies and the distortion frequencies. Nazarathy, U.S. Pat. No. 5,161,044 discloses a circuit in FIG. 15 that patent which produces essentially real, frequency-independent predistortion. The capacitors and inductors in Nazarathy are added for biasing purposes and to block the DC and AC currents. However, the circuit disclosed by Nazarthy may not have the right phase or frequency dependence for each set of input frequencies to be substantially the same in magnitude and opposite in sign to the distortion produced by the non-linear device.

The present invention accordingly is addressed to these and other difficulties found in packaged laser modules, and particularly such modules used in analog optical transmission systems.

### SUMMARY OF THE INVENTION

### 1. Objects of the Invention

It is an object of the present to provide an improved optical transmission system using a directly modulated laser with an integrated signal amplifier.

It is another object of the present to provide an improved optical transmitter using a modular, packaged laser and amplifier subassembly with a compact size and low power dissipation.

It is another object of the present invention to provide a laser transmitter for use with different optical transmission systems and optoelectric components, including one or more amplifier gain stages and predistortion circuitry.

It is another object of the present invention to provide an optical transmitter for use in an optical transmission system with a TEC cooler in the laser package for stabilizing the temperature of both the laser and the intermediate circuitry.

It is still another object of the present invention to provide an optical transmitter for use in an optical transmission system having a hermetically sealed package with the pre-distortion circuitry integrated in the package with the semiconductor laser.

### 2. Features of the Invention

Briefly, and in general terms, the present invention provides an modular, packaged optical transmitter including an analog signal input, a laser, and an amplifier circuit for directly modulating the laser.

In another aspect, the present invention provides an optical transmitter module including a housing having an electrical input for receiving a communications signal; an amplifier disposed in the housing connected to the electrical input for electronically amplifying the communications signal; and a laser disposed in the housing and connected to the amplifier for generating a modulated light beam that is emitted externally from the housing corresponding to the communications signal.

The present invention further provides a packaged laser including a predistortion circuit for reducing second and higher order distortion products produced by the nonlinear operation of the laser.

Additional objects, advantages, and novel features of the present invention will become apparent to those skilled in the art from this disclosure, including the following detailed description as well as by practice of the invention. While the invention is described below with reference to preferred embodiments, it should be understood that the invention is not limited thereto. Those of ordinary skill in the art having access to the teachings herein will recognize additional applications, modifications, and embodiments in other fields, which are within the scope of the invention as disclosed and claimed herein and with respect to which the invention could be of utility.

### BRIEF DESCRIPTION OF THE DRAWING

These and other features and advantages of this invention will be better understood and more fully appreciated by reference to the following detailed description when considered in conjunction with the accompanying drawings, wherein:

FIG. 1A is a highly simplified block diagram of an optical transmitter in a first exemplary embodiment in accordance with the prior art in which a driver and amplifier are external to the laser module.

FIG. 1B is a highly simplified block diagram of an optical transmitter in a second exemplary embodiment in accordance with the prior art in which a driver and pre-distorter circuits are external to the laser module.

FIG. 2 is a highly simplified block diagram of an optical transmitter in a first exemplary embodiment in accordance with the present invention in which the driver and amplifier are external to the laser module, and the predistorter and laser are integrated in a single package.

FIG. 3A is a highly simplified block diagram of an optical transmitter in a second exemplary embodiment in accordance with the present invention in which the driver is external to the laser module, and the amplifer and predistorter are integrated in the laser module.

FIG. 3B is a highly simplified block diagram of an optical transmitter in a third exemplary embodiment in accordance with the present invention in which the driver is external to the laser module, and the amplifer and predistorter are integrated in the laser module in a different sequence than in FIG. 3A.

FIG. 4A is a highly simplified block diagram of an optical transmitter in a fourth exemplary embodiment in accordance with the present invention in which the driver is external to the laser module, and the amplifer is integrated in the laser module over a TEC cooler.

FIG. 4B is a highly simplified block diagram of an optical transmitter in a fourth exemplary embodiment in accordance with the present invention in which the driver is external to the laser module, and the amplifer and the predistorter are integrated in the laser module over a TEC cooler.

FIG. 5 is a simplified schematic diagram of an optical transmitter having a high gain, high linearity source follower amplifier directly coupled to a laser in accordance with an exemplary embodiment of the present invention;

FIG. 6 is a simplified schematic diagram of an optical transmitter having a high gain, high linearity cascode amplifier directly coupled to a laser in accordance with an exemplary embodiment of the present invention;

FIG. 7 is a simplified schematic diagram of an optical transmitter having a high gain, high linearity common source amplifier directly coupled to a laser in accordance with an exemplary embodiment of the present invention;

FIG. 8 is is a simplified schematic diagram of an optical transmitter having a high gain, high linearity common source amplifier directly coupled to a laser in accordance with an exemplary embodiment of the present invention; and

FIG. 9 is a graph depicting the frequency response and input return loss of the circuit of FIG. 7.

FIG. 10 is a graph of the carrier to noise ratio (C/N), composite triple beat (CTB), and composite second order (CSO) distortions for a typical laser module with an integrated amplifier.

The novel features and characteristics of the invention are set forth in the appended claims. The invention itself, however, as well as other features and advantages thereof, will be best understood by reference to a detailed description of a specific embodiment, when read in conjunction with the accompanying drawings.

### DESCRIPTION OF THE PREFERRED EMBODIMENT

Details of the present invention will now be described, including exemplary aspects and embodiments thereof. Referring to the drawings and the following description, like reference numbers are used to identify like or functionally similar elements, and are intended to illustrate major features of exemplary embodiments in a highly simplified diagrammatic manner. Moreover, the drawings are not intended to depict every feature of actual embodiments or the relative dimensions of the depicted elements, and are not drawn to scale.

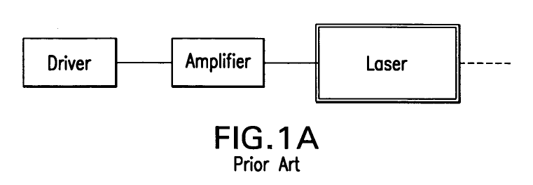

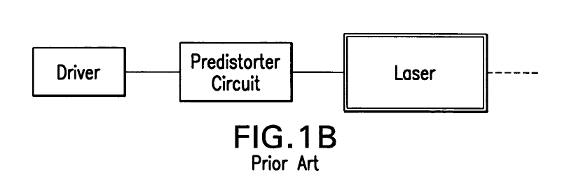

FIG. 1A is a highly simplified block diagram of an optical transmitter in a first exemplary embodiment in accordance with the prior art in which a driver and amplifier are external to the laser module.

FIG. 1B is a highly simplified block diagram of an optical transmitter in a second exemplary embodiment in accordance with the prior art in which a driver and pre-distorter circuits are external to the laser module.

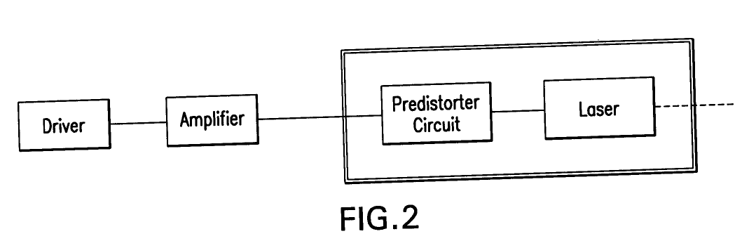

FIG. 2 is a highly simplified block diagram of an optical transmitter in a first exemplary embodiment in accordance with the present invention in which the driver and amplifier are external to the laser module, and the predistorter and laser are integrated in a single package. In one embodiment of the present invention a laser optical transmitter includes one or more amplifier stages external to the laser module, and a predistortion circuit integrated into the laser module.

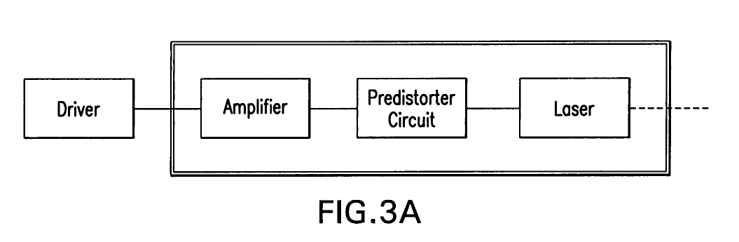

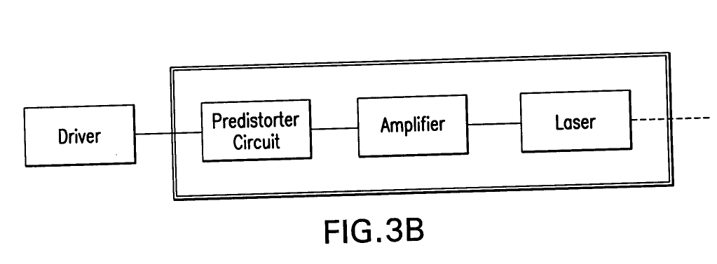

FIG. 3A is a highly simplified block diagram of an optical transmitter in a second exemplary embodiment in accordance with the present invention in which the driver is external to the laser module, and the amplifer and predistorter are integrated in the laser module. In this embodiment of the present invention a laser optical transmitter includes one or more amplifier stages internal to the laser module, and a predistortion circuit also integrated into the laser module. Such exemplary optical transmitter may be smaller than traditional transmitters by eliminating the impedence matching transformer and other large components, such as the amplifiers, thereby allowing for a greater density of devices to be integrated onto a printed circuit board. In addition, the power consumption of the described exemplary transmitter is also much lower than traditional devices since the gain stages are now positioned directly adjacent to the laser die, thereby eliminating the need for impedance matching resistors in series with the laser diode.

FIG. 3B is a highly simplified block diagram of an optical transmitter in a third exemplary embodiment in accordance with the present invention in which the driver is external to the laser module, and the amplifer and predistorter are integrated in the laser module in a different sequence than in FIG. 3A.

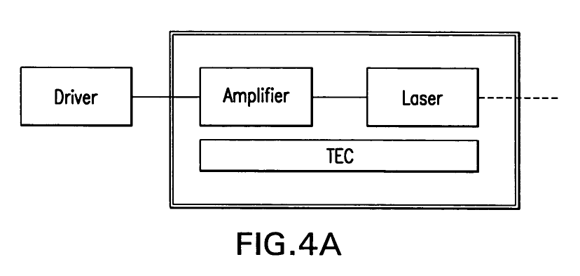

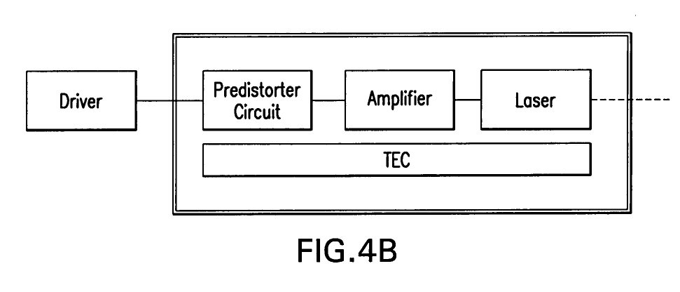

FIG. 4A is a highly simplified block diagram of an optical transmitter in a fourth exemplary embodiment in accordance with the present invention in which the driver is external to the laser module, and the amplifer is integrated in the laser module over a TEC cooler.

FIG. 4B is a highly simplified block diagram of an optical transmitter in a fourth exemplary embodiment in accordance with the present invention in which the driver is external to the laser module, and the amplifer and the predistorter are integrated in the laser module over a TEC cooler.

In the illustrated embodiment an analog data source 12 that provides an analog data signal for modulating the laser output is coupled to a predistorter 22. Distortion inherent in certain analog transmitters prevents a linear electrical modulation signal from being converted linearly to an optical signal, and instead causes the signal to become distorted.

The predistorter 22 generates a distortion signal that is combined with the analog modulation signal. The distortion so generated, or predistortion, is adjusted to be substantially equal in magnitude and opposite in sign to the second or higher order intermodulation product distortion inherent in the nonlinear laser 18. When the nonlinear laser 18 is modulated by the combined signal, the laser's inherent distortion is cancelled by the distortion signal generated by the predistorter 22, and only the linear part of the analog source signal is transmitted.

For example, in one embodiment the predistorter 22 divides the analog signal data into two or more electrical paths and generates predistortion on one or more of the paths resembling the distortion inherent in the nonlinear laser 18. The generated predistortion in the inverse of the nonlinear laser's 18 inherent distortion and serves to cancel the effect of the device's inherent distortion when recombined with the input signal before application to the non linear device.

In this embodiment the predistorter signal drives a gain stage 16 which in turn drives the non-linear laser 18. The gain stage may have multiple stages, and may receive one or more control signals for controlling various different parameters of the laser output, such as, for example, modulation amplitude and bias. In the described exemplary embodiment the gain stage 16 and the laser 18 are separated by a distance that is less than the RF transmission wavelength of the electrical signal. Therefore, in this embodiment the gain stage is directly coupled to the input of the laser without the need for an impedance matching resistor to reduce the impact of RF reflections. In addition, the gain stages in this embodiment may also be directly coupled to each other without intervening impedance matching resistors.

The described exemplary embodiment may therefore utilize a lower power supply voltage and has reduced power dissipation as compared to a conventional optical transmitter. The reduction in required voltage and power is largely attributable to the absence of impedance matching resistor(s) between the predistorted gain stages and the laser.

The laser 18 may be a laser diode, a Fabry Perot laser or any other optical transmitter suitable for optical communications. The optical receiver 22 receives the linear analog modulated transmit signal output by the laser 18 via the optical transmission medium 20. The optical receiver 22 may include one or more photodiodes for detecting the received optical signal and converting the received optical signal to an electrical signal.

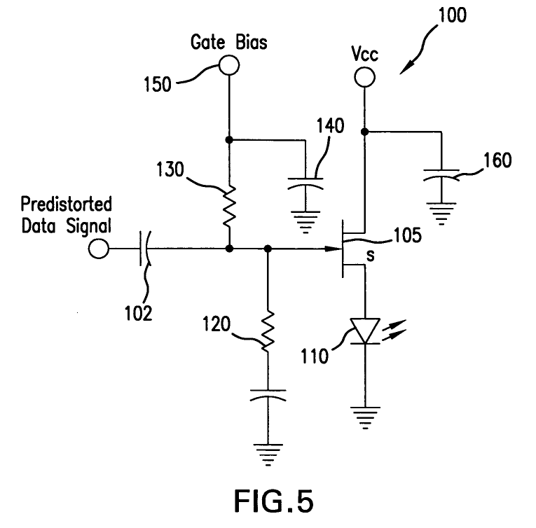

FIG. 5 is a schematic diagram of an optical transmitter 100 in an exemplary embodiment according to the present invention. For example, the optical transmitter 100 may be used as the optical transmitter in a fiber optic communications system. In some embodiments a DC blocking capacitor 102 couples a predistorted analog data signal with amplifier 105. The illustrated embodiment may further include an impedance matching resistor 120 shunted to ground. The impedance matching resistor 120 provides the required terminating impedance for the transmission line coupled to the input of the laser module thereby enabling a substantial matching between an input impedance of the laser module and the characteristic impedance of the transmission line.

The amplifier 105 is a high gain, high linearity device that modulates the laser 110 with the amplified analog data signal. In one embodiment, the amplifier comprises a single FET (field effect transistor) configured as a source follower (DC-coupled common drain) amplifier. In this embodiment the transistor's source is coupled directly to the laser 110. The transistor is coupled within a fraction of the RF wavelength of the electrical signal and provides a low output impedance drive signal for the laser 110 without the need for an intervening impedance matching resistor. In other embodiments, other transistors known to those skilled in the art may be used.

The illustrated optical transmitter 100 further includes a capacitor 130 and resistor 140 forming a bias tee network which couple a gate bias control signal 150 to the gate of the transistor 105 to DC bias the transistor to ensure linear operation. The resistor 130, provides a DC (direct current) load for the predistorted data signal and the capacitor 140 provides an AC shunt to ground.

In this embodiment capacitor 160 AC couples the drain of transistor 105 to ground. The capacitor 160 may comprise two capacitors in parallel, one with a relatively small capacitance (e.g., 60 to 100 pf) integrated within the laser module, and one with a larger capacitance (e.g., 0.1 uf) integrated outside the laser module.

The exemplary embodiment reduces the required supply voltage Vcc coupled for linear operation of transistor 104 because no resistor is used in series with the laser diode 110. For example, the maximum voltage drop across the laser when being driven by the maximum current is typically less than about 2.0V. Therefore, a nominal supply voltage Vcc of less than about 3.5V provides an adequate drain-to-gate voltage for efficient operation of transistor 105 under all conditions. In certain cases, the Vcc of the circuit may need to be optimized at a slightly higher voltage to achieve optimum distortion performance. In addition, in this embodiment the transistor is closely coupled to the laser. The elimination of the impedance matching resistor in series with the laser also reduces the power consumption of the transmitter as compared to conventional designs.

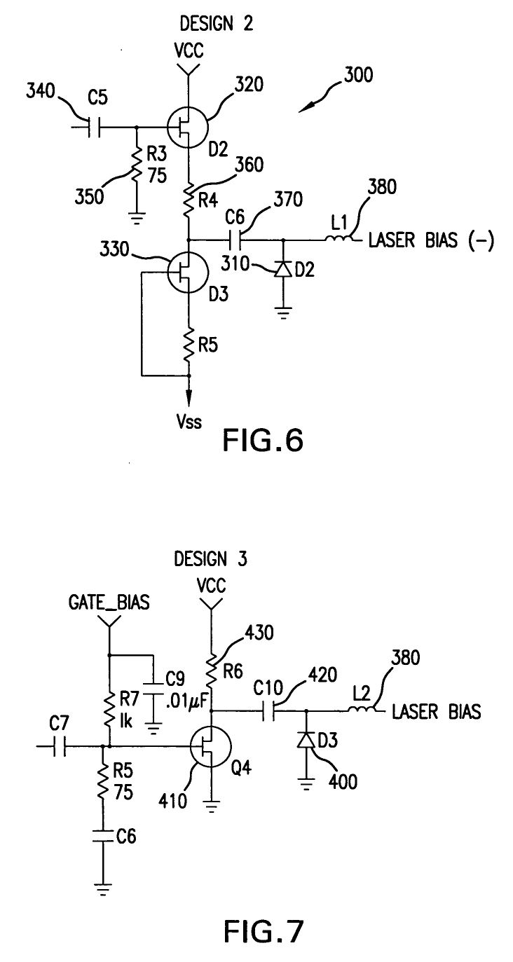

It will be appreciated by those of ordinary skill in the art that the invention can be embodied in other specific forms without departing from the spirit or essential character thereof. For example, one of skill in the art will appreciate that the present invention is not limited to the illustrated source-follower amplifier illustrated in FIG. 5. Rather a variety of high gain, high linearity amplifier designs may be used to implement the described exemplary low power optical transmitter. For example, in the simplified block diagram of FIG. 6, a cascode amplifier 300 is coupled directly to a laser 310 to provide a low power high linearity transmitter.

In this embodiment a DC blocking capacitor 340 couples a predistorted analog data signal with a cascade transistor (e.g. MOSFET 320). The illustrated embodiment may further include an impedance matching resistor 350 shunted to ground. The impedance matching resistor 350 again provides the required terminating impedance for the transmission line coupled to the input of the laser module thereby enabling a substantial matching between an input impedance of the laser module and the characteristic impedance of the transmission line.

In this embodiment, the source of the cascode transistor (e.g. MOSFET 320) is serially coupled to the drain of a transconductance transistor (e.g. MOSFET 330) through load resistor 360 which can be used to limit the gain of the device. In this embodiment DC blocking capacitor 370 couples the output of the amplifier taken at the junction between transistors 320 and 330 to laser 310. The laser may be DC biased through inductor 380.

FIG. 7 is a simplified schematic diagram of an optical transmitter having a high gain, high linearity common source amplifier directly coupled to the laser. The illustrates a further embodiment of the present invention that utilizes a common source amplifier, wherein the laser 400 is directly coupled to the drain of an FET transistor 410 through a DC blocking capacitor 420. In this embodiment load resistor 430 may be coupled between the supply voltage Vcc and the drain of the transistor 410 to set the gain of the device.

The present invention significantly reduces power consumption while maintaining relatively high performance as compared to traditional devices. For example, the cascade amplifier illustrated in FIG. 5 may be integrated adjacent to a laser die, thereby eliminating the need for impedance matching resistors in series with the laser diode.

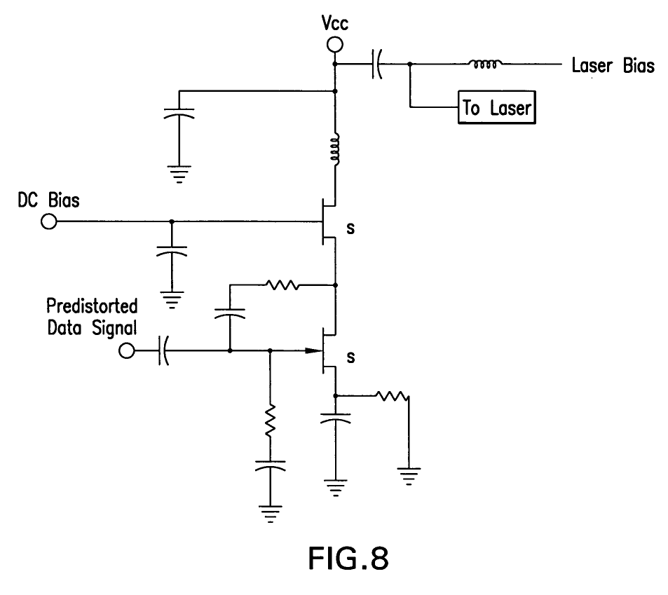

FIG. 8 is a simplified schematic diagram of an optical transmitter having a high gain, high linearity common source amplifier directly coupled to a laser in accordance with another exemplary embodiment of the present invention.

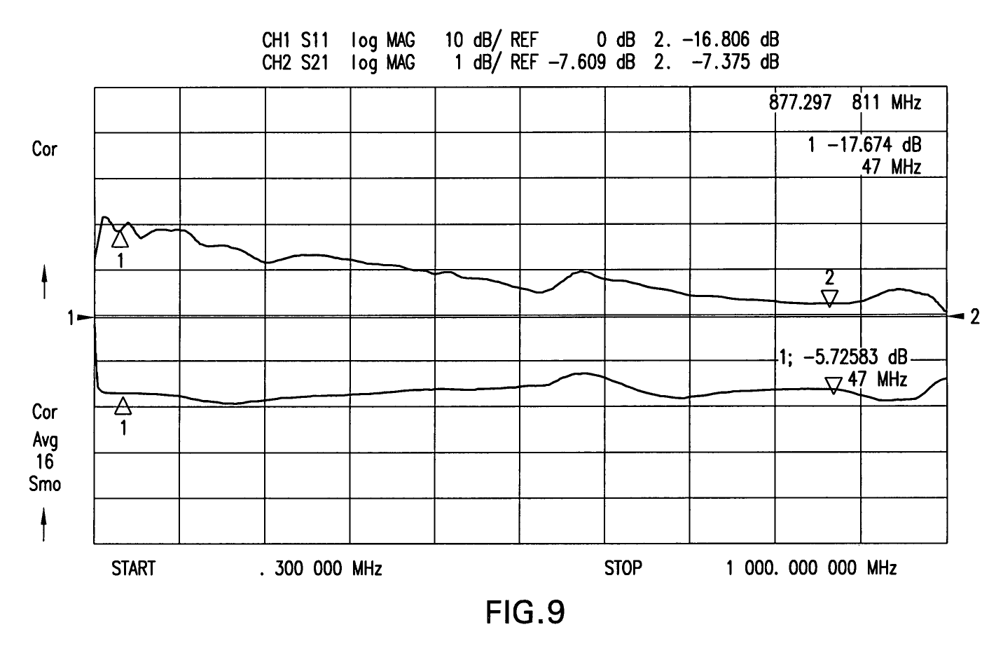

FIG. 9 is a graph depicting the frequency response and input return loss of the circuit of FIG. 7. In particular, it graphically illustrates the measured frequency response (S₂₁) and the input return loss (S₁₁) of the cascode amplifier as a function of frequency. The illustrated cascode amplifier provides relatively flat performance from 300 kHz to 1 GHz.

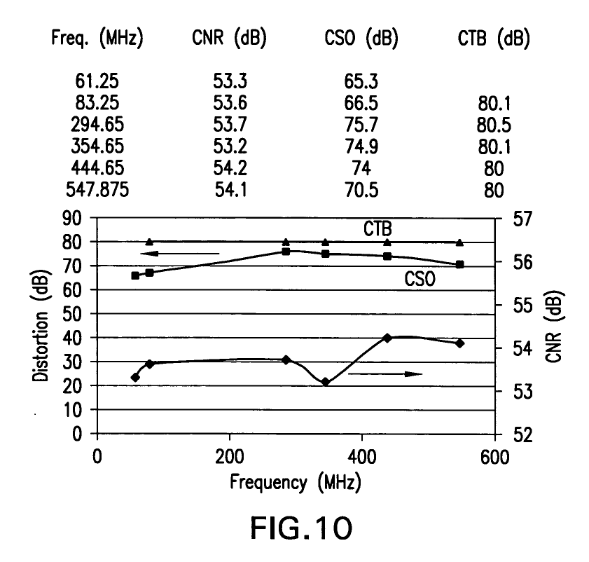

Similarly FIG. 10 graphically illustrates the carrier noise ratio (C/N), composite third order beat (CTB) and composite second order distortion (CSO) as a function of frequency. The illustrated amplifier meets or exceeds the typical performance criteria for transmitter gain stages, namely 53 dB carrier to noise ratio, 65 dB CTB and 65 dB CSO. The distortion performance of the illustrated optical transmitters is therefore typically limited by the performance of the predistorter circuit and the inherent non-linearity of the laser device.

Although this invention has been described in certain specific embodiments, many additional modifications and variations would be apparent to those skilled in the art. The present invention is therefore considered in all respects to be illustrative and not restrictive. The scope of the invention is indicated by the appended claims, and all changes that come within the meaning and range of equivalents thereof are intended to be embraced therein. For example, the optical interface in other embodiments may include two or more lenses. Further, the optical interface may also include two or more fold mirrors in the optical path to direct the optical beam to a desired location.

Various modifications and improvements of the present invention may also be apparent to those of ordinary skill in the art. Thus, the particular combination of parts described and illustrated herein is intended to represent only certain embodiments of the present invention, and is not intended to serve as limitations of alternate devices within the spirit and scope of the invention. Various aspects of the techniques and apparatus associated with the pre-distortion signal processing aspect of the invention may be implemented in digital circuitry, or in computer hardware, firmware, software, or in combinations of them. Apparatus of the invention may be implemented in computer products tangibly embodied in a machine-readable storage device for execution by a programmable processor, or on software located at a network node or web site which may be downloaded to the transmitter automatically or on demand. The foregoing techniques may be performed, for example, single central processor, a multiprocessor, on one or more digital signal processors, gate arrays of logic gates, or hardwired logic circuits for executing a sequence of signals or program of instructions to perform functions of the invention by operating on input data and generating output. The methods may advantageously be implemented in one or more computer programs that are executable on a programmable system including at least one programmable processor coupled to receive data and instructions from, and to transmit data and instructions to, a data storage system, at least one in/out device, and at least one output device. Each computer program may be implemented in a high-level procedural or object-oriented programming language, or in assembly or machine language if desired; and in any case, the language may be compiled or interpreted language. Suitable processors include by way of example, both general and special purpose microprocessors. Generally, a processor will receive instructions and data from read-only memory and/or random access memory. Storage devices suitable for tangibly embodying computer program instructions and data include all forms of non-volatile memory, including by way of example, semiconductor devices, such as EPROM, EEPROM, and flash memory devices; magnetic disks such as internal hard disks and removable disks; magneto-optical disks; and CD-ROM disks. Any of the foregoing may be supplemented by or incorporated in, specifically designed application-specific integrated circuits (ASICS).

It will be understood that each of the elements described above, or two or more together, also may find a useful application in other types of constructions differing from the types described above.

While the invention has been illustrated and described as embodied in a transmitter for an optical communications network, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

1. An optical transmitter module comprising:
a housing including an electrical input for receiving a communications signal;
an amplifier disposed in said housing connected to the electrical input for electronically amplifying the communications signal; and
a laser disposed in said housing and connected to said amplifier for generating a modulated light beam that is emitted externally from said housing corresponding to said communications signal.

2. A transmitter as defined in claim 1, wherein the laser is amplitude modulated by the electrical communications signal.

3. A transmitter as defined in claim 1, wherein the housing is hermetically sealed.

4. A transmitter as defined in claim 1, wherein the amplifier includes a bipolar transistor configured as a common collector amplifier.

5. A transmitter as defined in claim 1, wherein the amplifier includes a FET configured as a common drain amplifier.

6. A transmitter as defined in claim 1, wherein said communications signal is an analog radio frequency signal.

7. A transmitter as defined in claim 7, further comprising a pre-distortion circuit connected to the amplifier and disposed in said housing.

8. An optical transmitter module comprising:
a housing, including an electrical input for receiving a communications signal;
a pre-distortion circuit disposed in said housing connected to the electrical input for electronically modifying the communications signal; and
a laser disposed in said housing and connected to said circuit for generating a modulated light beam that is emitted externally from said housing corresponding to said communications signal.
a transmitter as defined in claim 1, wherein the laser is amplitude modulated by the electrical communications signal.

9. A transmitter as defined in claim 8, wherein the housing is hermetically sealed.

10. A transmitter as defined in claim 8, wherein said communications signal is an analog radio frequency signal.

11. An optical transmitter for converting and coupling an information-containing electrical signal with an optical fiber comprising;
a housing including an electrical input for coupling the transmitter with an external printed circuit board and for receiving an information-containing electrical communications signal, and an optical signal output adapted for coupling with an external optical fiber for transmitting an optical communications signal;
at least one semiconductor laser in the housing for converting between an information-containing electrical signal and a modulated optical signal corresponding to the electrical signal; and
a processing circuit in the housing for processing the communications signal into a modulating electrical signal;

12. An optical transmitter comprising;
a driver circuit for receiving an input information signal and for producing a modulated current output; and
a packaged laser module, including an intermediate circuit connected to the driver circuit, and a semiconductor laser connected to the intermediate circuit for producing a modulated light beam representative of the input information signal, and a temperature control element for controlling the ambient temperature of the intermediate circuit and the laser.

13. A transmitter as defined in claim 12 wherein the packaged module is hermetically sealed.

14. A transmitter as defined in claim 12 wherein the intermediate circuit is a pre-distortion circuit.

15. The optical transmitter as defined in claim 12 wherein the amplifier comprises a source follower amplifier and wherein the laser is coupled to a source of an amplifier transistor.

16. The optical transmitter as defined in claim 12 wherein the amplifier comprises a cascode amplifier and wherein the laser is coupled between a cascode transistor and a transconductance transistor.

17. The optical transmitter as defined in claim 12, wherein the amplifier comprises a common source amplifier and wherein the laser is coupled to drain of an amplifier transistor.

18. The optical transmitter as defined in claim 12, further comprising a DC blocking capacitor coupled to the first electrode of the between the amplifier and the predistorted analog input signal.

19. The optical transmitter as defined in claim 12, further comprising an inductor coupled between the laser diode and a laser bias control signal, wherein the inductor provides a DC current path to the laser diode.

20. The optical transmitter as defined in claim 12, further comprising an impedance matching resistor coupled between the first electrode of the amplifier and ground.

21. The optical transmitter as defined in claim 12, further comprising a predistortion circuit coupled to first electrode of the amplifier, wherein the predistortion circuit generates a predistortion signal that is substantially equal in magnitude and opposite in sign to inherent distortion generated by the laser diode.
